(19) United States
(12) Patent Application Publication
(10) Pub. No.: US 2007/0222788 A1
(43) Pub. Date: Sep. 27, 2007

(54) Method and system for sharing user interface rendering among heterogeneous architectures

(75) Inventor: Howard A. Abrams, San Francisco, CA (US)

Correspondence Address: BAKER BOTTS L.L.P., 2001 ROSS AVENUE, SUITE 600, DALLAS, TX, 75201-2980, US

(73) Assignee: COMPUTER ASSOCIATES THINK, INC.

(21) Appl. No.: 11/385,441

(22) Filed: Mar. 21, 2006

(51) Int. Cl. G09G 5/00

(52) U.S. Cl. 345/581

(57) ABSTRACT

According to various illustrative embodiments of the present invention, a method for sharing rendering of a user interface component for an information handling application comprises instructing a plurality of information handling application components, using an information handling application code, to send a particular component to be rendered by one of a plurality of universal renderers, wherein each universal renderer is associated with a respective one of the information handling application components. The method continues by rendering the particular information handling application component to produce a rendered information handling application component. The method concludes by providing the rendered information handling application component to an information handling application rendering library, so that when a plurality of the information handling application components has been rendered, then the information handling application rendering library will comprise the set of rendered information handling application components.

### TECHNICAL FIELD OF THE INVENTION

The present invention relates generally to information processing and, more particularly, to systems and methods for improving implementations of a user interface by sharing the renderings of user interface components.

### BACKGROUND OF THE INVENTION

As the value and use of information continues to increase, individuals and businesses continually seek additional ways to process and store information. Improving the user interface (UI) with underlying applications is an important aspect of facilitating the processing and storing of information.

Separating the rendering of what ultimately gets presented to the user by the user interface (UI) from the application data model of a user interface component is one conventional technique that helps decouple the “look and feel” of what is rendered to the user from the underlying application data model, using a component framework as a go-between. This separation allows developers to specify what data the user interface (UI) will ultimately present to the user without embedding any details into the application data model itself, and without specifying how the data will look to the user.

For example, as shown at 100 in FIG. 1, a conventional rendering of what ultimately gets presented to the user by the user interface (UI) from the application data model of a user interface component is illustrated. A Java Swing toolkit application code 110 instructs a Java Swing toolkit components framework 120, comprising a set of Java Swing toolkit components JST₁, JST₂, . . . , JSTₙ, where n may be any non-zero integer, to send a particular component, such as JSTₖ, where k may be any non-zero integer less than or equal to n, to be rendered by Java Swing toolkit renderers 130. The Java Swing toolkit renderers 130 comprise a set of n Java Swing toolkit renderers JSTR₁, JSTR₂, . . . , JSTRₙ, each specific to a respective one of the Java Swing toolkit components JST₁, JST₂, . . . , JSTₙ, where n may be any non-zero integer. For example, the Java Swing toolkit renderer JSTRₖ specifically renders the Java Swing toolkit component JSTₖ, producing a rendered Java Swing toolkit component JSTRₖ[JSTₖ], where k may be any non-zero integer less than or equal to n. The rendered Java Swing toolkit component JSTRₖ[JSTₖ], where k may be any non-zero integer less than or equal to n, may be provided to a Java Swing toolkit rendering library 140. When every one of the Java Swing toolkit components JST₁, JST₂, . . . , JSTₙ, has been rendered, then the Java Swing toolkit rendering library 140 comprises the set of rendered Java Swing toolkit components JSTR₁[JST₁], JSTR₂[JST₂], . . . , JSTRₙ[JSTₙ], where n may be any non-zero integer.

Similarly, as shown at 200 in FIG. 2, for example, another conventional rendering of what ultimately gets presented to the user by the user interface (UI) from the application data model of a user interface component is illustrated. A JavaServer Faces standard application code 210 instructs a JavaServer Faces standard components framework 220, comprising a set of JavaServer Faces standard components JSF₁, JSF₂, . . . , JSFₙ, where n may be any non-zero integer, to send a particular component, such as JSFₖ, where k may be any non-zero integer less than or equal to n, to be rendered by JavaServer Faces standard renderers 230. The JavaServer Faces standard renderers 230 comprise a set of n JavaServer Faces standard renderers JSFR₁, JSFR₂, . . . , JSFRₙ, each specific to a respective one of the JavaServer Faces standard components JSF₁, JSF₂, . . . , JSFₙ, where n may be any non-zero integer. For example, the JavaServer Faces standard renderer JSFRₖ specifically renders the JavaServer Faces standard component JSFₖ, producing a rendered JavaServer Faces standard component JSFRₖ[JSFₖ], where k may be any non-zero integer less than or equal to n. The rendered JavaServer Faces standard component JSFRₖ[JSFₖ], where k may be any non-zero integer less than or equal to n, may be provided to a JavaServer Faces standard rendering library 240. When every one of the JavaServer Faces standard components JSF₁, JSF₂, . . . , JSFₙ, has been rendered, then the JavaServer Faces standard rendering library 240 comprises the set of rendered JavaServer Faces standard components JSFR₁[JSF₁], JSFR₂[JSF₂], JSFRₙ[JSFₙ], where n may be any non-zero integer.

However, as shown in the Java Swing toolkit and the JavaServer Faces standard rendering implementations described above, whenever a new user interface component is developed, multiple new corresponding component renderers have to be developed as well, one for each toolkit and/or technology in use. For example, if a new Java Swing toolkit component JSTₙ₊₁, is developed, a corresponding new Java Swing toolkit renderer JSTRₙ₊₁ has to be developed to be able to render the new rendered Java Swing toolkit component JSTRₙ₊₁[JSTₙ₊₁], to the Java Swing toolkit rendering library 140. Similarly, if a new JavaServer Faces standard component JSFₙ₊₁, is developed, a corresponding new JavaServer Faces standard renderer JSFRₙ₊₁ has to be developed to be able to render the new rendered JavaServer Faces standard component JSFRₙ₊₁[JSFₙ₊₁], to the JavaServer Faces standard rendering library 240.

### SUMMARY OF THE INVENTION

According to various illustrative embodiments of the present invention, a method for sharing rendering of a user interface component for an information handling application comprises instructing a plurality of information handling application components, using an information handling application code, to send a particular component to be rendered by one of a plurality of universal renderers, wherein each universal renderer is associated with a respective one of the information handling application components. The method continues by rendering the particular information handling application component to produce a rendered information handling application component. The method concludes by providing the rendered information handling application component to an information handling application rendering library, so that when a plurality of the information handling application components has been rendered, then the information handling application rendering library will comprise the set of rendered information handling application components.

Various embodiments of the present invention may benefit from numerous advantages. It should be noted that one or more embodiments may benefit from some, none, or all of the advantages discussed below. The system and method disclosed herein are advantageous in providing a mechanism for reusing the renderer for a given component regardless of the underlying user interface framework or technology. In various illustrative embodiments, this may be accomplished through the use of adapters to isolate the renderers from the rendering technology and the respective user interface components. Other technical advantages will be apparent to those of ordinary skill in the art having the benefit of the present disclosure and in view of the following specification, claims, and drawings.

### BRIEF DESCRIPTION OF THE DRAWINGS

For a more complete understanding the present invention and its advantages, reference is now made to the following description, taken in conjunction with the accompanying drawings, in which:

FIG. 1 illustrates a block diagram showing a computer system, according to prior teachings;

FIG. 2 illustrates a block diagram showing another computer system, according to prior teachings;

FIG. 3 illustrates a block diagram showing an overview of an Internet-based (client/server) system, according to teachings of the present disclosure;

FIG. 4 illustrates an exemplary embodiment of a method for sharing renderings of user interface components for a web browser, according to teachings of the present disclosure;

FIG. 5 illustrates an exemplary embodiment of a method for sharing renderings of user interface components for a desktop application, according to teachings of the present disclosure;

FIG. 6 illustrates an exemplary embodiment of a method for sharing renderings of user interface components for a handheld computer application, according to teachings of the present disclosure;

FIG. 7 illustrates an exemplary embodiment of a method for sharing renderings of user interface components for a cell phone, according to teachings of the present disclosure; and

FIG. 8 illustrates a method for sharing renderings of user interface components, according to teachings of the present disclosure.

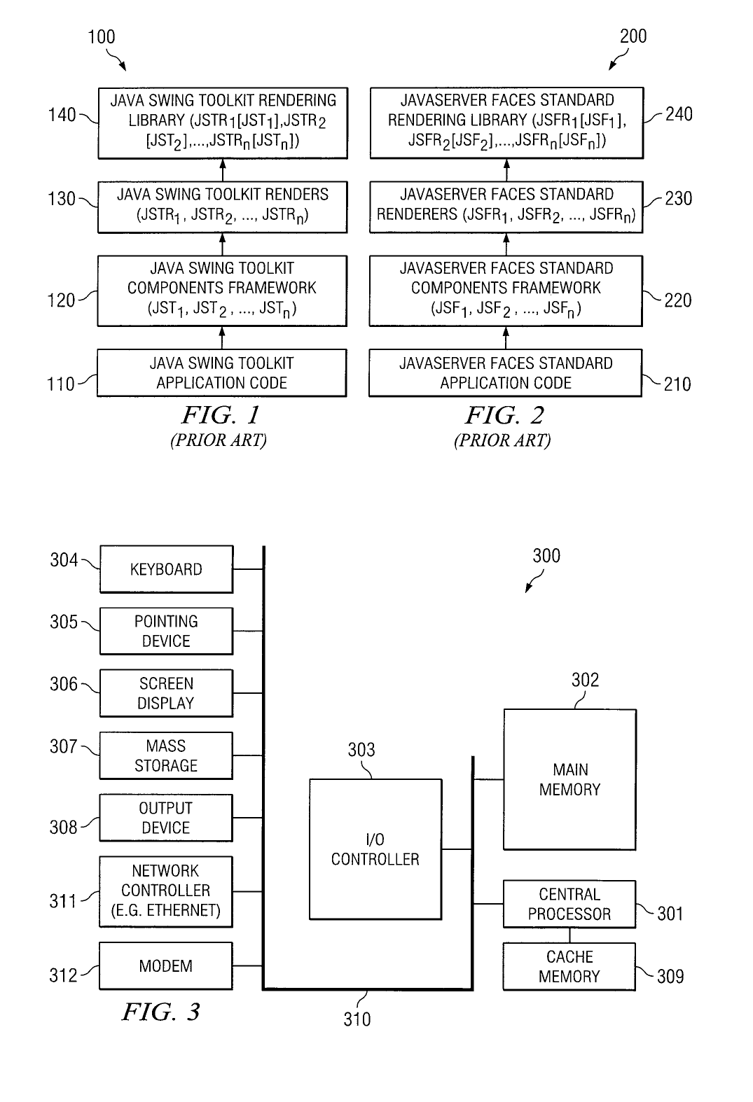

### DETAILED DESCRIPTION OF ILLUSTRATIVE EMBODIMENTS OF THE INVENTION

Illustrative embodiments of the present invention are described in detail below. The following description will focus on various illustrative embodiments, which may be operative in an Internet-connected environment, including, for instance, client machines running under the Microsoft® Windows® environment and connected to an open network, such as a wide area network (WAN) and/or the Internet. The present invention, however, is not limited to any particular one application or any particular environment. Instead, those skilled in the art having the benefit of the present disclosure will find that the system and methods of the present invention may be advantageously applied to a variety of system and application software, including database management systems, word processors, spreadsheets, and the like, operating on a variety of different platforms, including the Macintosh® operating system, the UNIX® operating system, the NextStep® operating system, and the like. Therefore, the description of the exemplary embodiments that follows is for purposes of illustration and not limitation.

Various illustrative embodiments may generally be embodied on an information processing system including one or more computer systems, such as a computer system 300 of FIG. 3, operating on a network. The computer system 300 may comprise a central processor 301, a main memory 302, an input/output controller 303, a keyboard 304, a pointing device 305 (e.g., a mouse, a track ball, a pen device, and/or the like), a display and/or screen device 306, and a mass storage 307 (e.g., a hard disk or a fixed disk, a removable floppy disk, an optical disk, a magneto-optical disk, a flash memory, and/or the like), a network interface card or controller 311 (e.g., Ethernet, Firewire, and/or the like), and a modem 312 (e.g., a 56K baud modem, an ISDN modem, a DSL modem and/or the like). Although not shown separately, a real-time system clock may be included with the computer system 300, in a conventional manner. The computer processor 301 may include and/or be coupled to a cache memory 309 for storing frequently accessed information. The cache memory 309 may be an on-chip cache and/or an external cache (as shown). One or more input/output (I/O) device(s) 308, such as a printing device and/or a slide output device, may be included in the computer system 300, as desired. As shown, the various components of the computer system 300 may communicate through a system bus 310 and/or a similar architecture. The computer system 300 itself may communicate with other computer systems via the network interface card 311 and/or the modem 312.

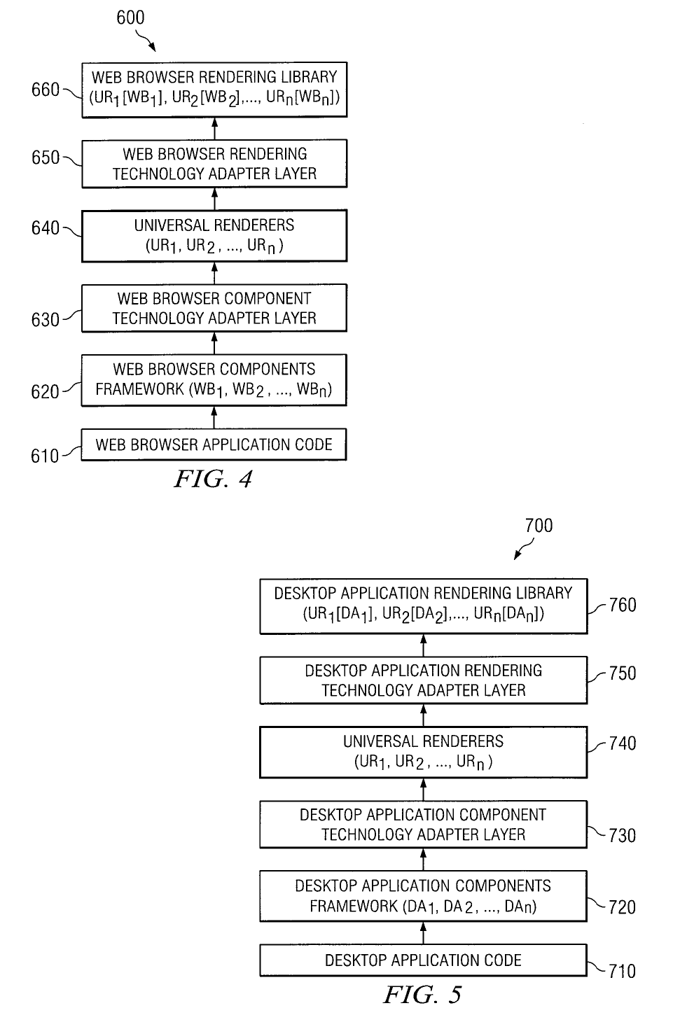

In various illustrative embodiments, a method and system for sharing renderings of user interface components for an information handling application is provided to reuse the renderer for a given component regardless of the underlying user interface framework or technology. In various illustrative embodiments, this may be accomplished through the use of adapters to isolate the renderers from the rendering technology and the respective user interface components. Referring to FIG. 4, an exemplary embodiment of a method for sharing renderings of user interface components for a web browser is illustrated, according to teachings of the present disclosure, as shown at 600, for example. A web browser application code 610 may instruct a web browser components framework 620, comprising a set of web browser components WB₁, WB₂, . . . , WBₙ, where n may be any non-zero integer, to send a particular component, such as WBₖ, where k may be any non-zero integer less than or equal to n, to be rendered by universal renderers 640. The universal renderers 640 may comprise a set of n universal renderers UR₁, UR₂, . . . , URₙ, each applicable to a respective one of the web browser components WB₁, WB₂, . . . , WBₙ, where n may be any non-zero integer. For example, the universal renderer URₖ may specifically render the web browser component WBₖ, producing a rendered web browser component URₖ[WBₖ], where k may be any non-zero integer less than or equal to n. The rendered web browser component URₖ[WBₖ], where k may be any non-zero integer less than or equal to n, may be provided to a web browser rendering library 660. When every one of the web browser components WB₁, WB₂, . . . , WBₙ, has been rendered, then the web browser rendering library 660 may comprise the set of rendered web browser components UR₁[WB₁], UR₂[WB₂], . . . , URₙ[WBₙ], where n may be any non-zero integer.

In various illustrative embodiments, as shown in FIG. 4, for example, a web browser component technology adapter layer 630 may optionally be disposed between the web browser components framework 620 and the universal renderers 640. In various other illustrative embodiments, a web browser rendering technology adapter layer 650 may optionally be disposed between the universal renderers 640 and the web browser rendering library 660. In still other various illustrative embodiments, the web browser component technology adapter layer 630 may optionally be disposed between the web browser components framework 620 and the universal renderers 640, and the web browser rendering technology adapter layer 650 may also optionally be disposed between the universal renderers 640 and the web browser rendering library 660.

Referring to FIG. 5, another exemplary embodiment of a method and system for sharing renderings of user interface components for a desktop application is illustrated, according to teachings of the present disclosure, as shown at 700, for example. A desktop application code 710 may instruct a desktop application components framework 720, comprising a set of desktop application components DA₁, DA₂, . . . , DAₙ, where n may be any non-zero integer, to send a particular component, such as DAₖ, where k may be any non-zero integer less than or equal to n, to be rendered by universal renderers 740. The universal renderers 740 may comprise a set of n universal renderers UR₁, UR₂, . . . , URₙ, each applicable to a respective one of the desktop application components DA₁, DA₂, . . . , DAₙ, where n may be any non-zero integer. For example, the universal renderer URₖ may specifically render the desktop application component DAₖ, producing a rendered desktop application component URₖ[DAₖ], where k may be any non-zero integer less than or equal to n. The rendered desktop application component URₖ[DAₖ], where k may be any non-zero integer less than or equal to n, may be provided to a desktop application rendering library 760. When every one of the desktop application components DA₁, DA₂, . . . , DAₙ, has been rendered, then the desktop application rendering library 760 may comprise the set of rendered desktop application components UR₁[DA₁], UR₂[DA₂], . . . , URₙ[DAₙ], where n may be any non-zero integer.

In various illustrative embodiments, as shown in FIG. 5, for example, a desktop application component technology adapter layer 730 may optionally be disposed between the desktop application components framework 720 and the universal renderers 740. In various other illustrative embodiments, a desktop application rendering technology adapter layer 750 may optionally be disposed between the universal renderers 740 and the desktop application rendering library 760. In still other various illustrative embodiments, the desktop application component technology adapter layer 730 may optionally be disposed between the desktop application components framework 720 and the universal renderers 740, and the desktop application rendering technology adapter layer 750 may also optionally be disposed between the universal renderers 740 and the desktop application rendering library 760.

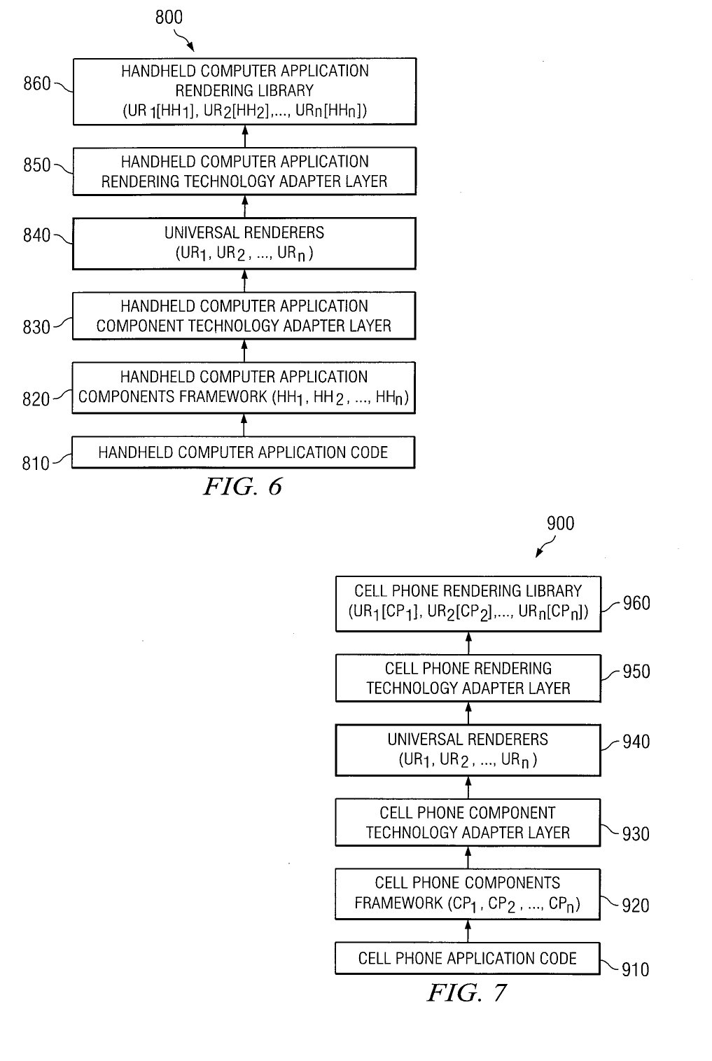

Referring to FIG. 6, another exemplary embodiment of a method and system for sharing renderings of user interface components for a handheld computer application is illustrated, according to teachings of the present disclosure, as shown at 800, for example. A handheld computer application code 810 may instruct a handheld computer application components framework 820, comprising a set of handheld computer application components HH₁, HH₂, . . . , HHₙ, where n may be any non-zero integer, to send a particular component, such as HHₖ, where k may be any non-zero integer less than or equal to n, to be rendered by universal renderers 840. The universal renderers 840 may comprise a set of n universal renderers UR₁, UR₂, . . . , URₙ, each applicable to a respective one of the handheld computer application components HH₁, HH₂, . . . , HHₙ, where n may be any non-zero integer. For example, the universal renderer URₖ may specifically render the handheld computer application component HHₖ, producing a rendered handheld computer application component URₖ[HHₖ], where k may be any non-zero integer less than or equal to n. The rendered handheld computer application component URₖ[HHₖ], where k may be any non-zero integer less than or equal to n, may be provided to a handheld computer application rendering library 860. When every one of the handheld computer application components HH₁, HH₂, . . . , HHₙ, has been rendered, then the handheld computer application rendering library 860 may comprise the set of rendered handheld computer application components UR₁[HH₁], UR₂[HH₂], URₙ[HHₙ], where n may be any non-zero integer.

In various illustrative embodiments, as shown in FIG. 6, for example, a handheld computer application component technology adapter layer 830 may optionally be disposed between the handheld computer application components framework 820 and the universal renderers 840. In various other illustrative embodiments, a handheld computer application rendering technology adapter layer 850 may optionally be disposed between the universal renderers 840 and the handheld computer application rendering library 860. In still other various illustrative embodiments, the handheld computer application component technology adapter layer 830 may optionally be disposed between the handheld computer application components framework 820 and the universal renderers 840, and the handheld computer application rendering technology adapter layer 850 may also optionally be disposed between the universal renderers 840 and the handheld computer application rendering library 860.

Referring to FIG. 7, another exemplary embodiment of a method and system for sharing renderings of user interface components for a cell phone is illustrated, according to teachings of the present disclosure, as shown at 900, for example. A cell phone application code 910 may instruct a cell phone components framework 920, comprising a set of cell phone components CP₁, CP₂, . . . , CPₙ, where n may be any non-zero integer, to send a particular component, such as CPₖ, where k may be any non-zero integer less than or equal to n, to be rendered by universal renderers 940. The universal renderers 940 may comprise a set of n universal renderers UR₁, UR₂, . . . , URₙ, each applicable to a respective one of the cell phone components CP₁, CP₂, . . . , CPₙ, where n may be any non-zero integer. For example, the universal renderer URₖ may specifically render the cell phone component CPₖ, producing a rendered cell phone component URₖ[CPₖ], where k may be any non-zero integer less than or equal to n. The rendered cell phone component URₖ[CPₖ], where k may be any non-zero integer less than or equal to n, may be provided to a cell phone rendering library 960. When every one of the cell phone components CP₁, CP₂, . . . , CPₙ, has been rendered, then the cell phone rendering library 960 may comprise the set of rendered cell phone components UR₁[CP₁], UR₂[CP₂], . . . , URₙ[CPₙ], where n may be any non-zero integer.

In various illustrative embodiments, as shown in FIG. 7, for example, a cell phone component technology adapter layer 930 may optionally be disposed between the cell phone components framework 920 and the universal renderers 940. In various other illustrative embodiments, a cell phone rendering technology adapter layer 950 may optionally be disposed between the universal renderers 940 and the cell phone rendering library 960. In still other various illustrative embodiments, the cell phone component technology adapter layer 930 may optionally be disposed between the cell phone components framework 920 and the universal renderers 940, and the cell phone rendering technology adapter layer 950 may also optionally be disposed between the universal renderers 940 and the cell phone rendering library 960.

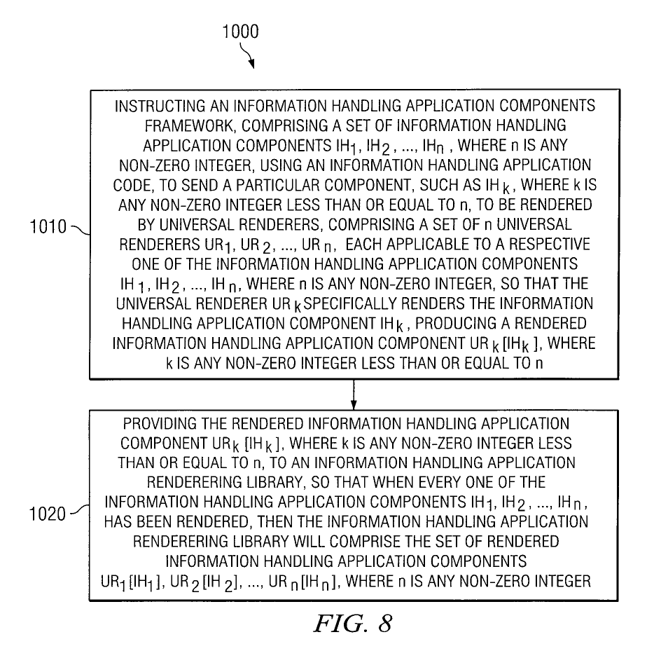

FIG. 8 illustrates a method 1000 for sharing renderings of user interface components, according to teachings of the present disclosure. The method 1000 for sharing rendering of a user interface component for an information handling application may comprise instructing an information handling application components framework, comprising a set of information handling application components IH₁, IH₂, . . . , IHₙ, where n is any non-zero integer, using an information handling application code, to send a particular component, such as IHₖ, where k is any non-zero integer less than or equal to n, to be rendered by universal renderers, comprising a set of n universal renderers UR₁, UR₂, . . . , URₙ, each applicable to a respective one of the information handling application components IH₁, IH₂, . . . , IHₙ, where n is any non-zero integer, so that the universal renderer URₖ specifically renders the information handling application component IHₖ, producing a rendered information handling application component URₖ[IHₖ], where k is any non-zero integer less than or equal to n, as indicated at 1010. The method may also comprise providing the rendered information handling application component URₖ[IHₖ], where k is any non-zero integer less than or equal to n, to an information handling application rendering library, so that when every one of the information handling application components IH₁, IH₂, . . . , IHₙ, has been rendered, then the information handling application rendering library will comprise the set of rendered information handling application components UR₁[IH₁], UR₂[IH₂], . . . , URₙ[IHₙ], where n is any non-zero integer, as indicated at 1020.

Although various illustrative embodiments of the present invention and their advantages are described in detail, a person skilled in the art having the benefit of the present disclosure could make various alterations, additions, and/or omissions without departing from the spirit and scope of the present invention, as defined by the appended claims.

What is claimed is:

1. A method for sharing rendering of a user interface component for an information handling application, the method comprising:
instructing an information handling application components framework, comprising a set of information handling application components IH₁, IH₂, . . . , IHₙ, where n is any non-zero integer, using an information handling application code, to send a particular component, such as IHₖ, where k is any non-zero integer less than or equal to n, to be rendered by universal renderers, comprising a set of n universal renderers UR₁, UR₂, . . . , URₙ, each applicable to a respective one of the information handling application components IH₁, IH₂, . . . , IHₙ, where n is any non-zero integer, so that the universal renderer URₖ specifically renders the information handling application component IHₖ, producing a rendered information handling application component URₖ[IHₖ], where k is any non-zero integer less than or equal to n; and
providing the rendered information handling application component URₖ[IHₖ], where k is any non-zero integer less than or equal to n, to an information handling application rendering library, so that when a plurality of the information handling application components IH₁, IH₂, . . . , IHₙ, has been rendered, then the information handling application rendering library will comprise the set of rendered information handling application components UR₁[IH₁], UR₂[IH₂], . . . , URₙ[IHₙ], where n is any non-zero integer.

2. The method of claim 1, further comprising disposing an information handling application component technology adapter layer between the information handling application components framework and the universal renderers.

3. The method of claim 1, further comprising disposing an information handling application rendering technology adapter layer between the universal renderers and the information handling application rendering library.

4. The method of claim 1, wherein the information handling application comprises at least one of a web browser, a desktop application, a handheld computer application, and a cell phone.

5. A system for sharing rendering of a user interface component for an information handling application, the system comprising:
an information handling application components framework, comprising a set of information handling application components IH₁, IH₂, . . . , IHₙ, where n is any non-zero integer;
universal renderers, comprising a set of n universal renderers UR₁, UR₂, . . . , URₙ, each applicable to a respective one of the information handling application components IH₁, IH₂, . . . , IHₙ, where n is any non-zero integer, so that a universal renderer URₖ is capable of specifically rendering a particular information handling application component IHₖ, producing a rendered information handling application component URₖ[IHₖ], where k is any non-zero integer less than or equal to n;
a memory operable to store:
an information handling application code capable of instructing the information handling application components framework to send the particular component IHₖ, where k is any non-zero integer less than or equal to n, to be rendered; and
an information handling application rendering library capable of being provided the rendered information handling application component URₖ[IHₖ], where k is any non-zero integer less than or equal to n, so that when a plurality of the information handling application components IH₁, IH₂, . . . , IHₙ, has been rendered, then the information handling application rendering library will comprise the set of rendered information handling application components UR₁[IH₁], UR₂[IH₂], . . . , URₙ[IHₙ], where n is any non-zero integer.

6. The system of claim 5, further comprising an information handling application component technology adapter layer disposed between the information handling application components framework and the universal renderers.

7. The system of claim 5, further comprising an information handling application rendering technology adapter layer disposed between the universal renderers and the information handling application rendering library.

8. The system of claim 5, wherein the information handling application comprises at least one of a web browser, a desktop application, a handheld computer application, and a cell phone.

9. A method for sharing rendering of a user interface component for an information handling application, the method comprising:
instructing a plurality of information handling application components, using an information handling application code, to send a particular component to be rendered by one of a plurality of universal renderers, wherein each universal renderer is associated with a respective one of the information handling application components;
rendering the particular information handling application component to produce a rendered information handling application component; and
providing the rendered information handling application component to an information handling application rendering library, so that when a plurality of the information handling application components has been rendered, then the information handling application rendering library will comprise the set of rendered information handling application components.

10. The method of claim 9, further comprising disposing an information handling application component technology adapter layer between the information handling application components framework and the universal renderers.

11. The method of claim 9, further comprising disposing an information handling application rendering technology adapter layer between the universal renderers and the information handling application rendering library.

12. The method of claim 9, wherein the information handling application comprises at least one of a web browser, a desktop application, a handheld computer application, and a cell phone.

13. A system for sharing rendering of a user interface component for an information handling application, the system comprising:
an information handling application components framework, comprising a plurality of information handling application components;
a plurality of universal renderers, wherein each universal renderer is applicable to a respective one of the information handling application components, so that a particular universal renderer is capable of rendering a particular information handling application component to thereby produce a rendered information handling application component;
a memory operable to store:
information handling application code capable of instructing the information handling application components framework to send the particular information handling application component to be rendered; and
an information handling application rendering library capable of being provided the rendered information handling application component so that when a plurality of the information handling application components has been rendered, then the information handling application rendering library will comprise the set of rendered information handling application components.

14. The system of claim 13, further comprising an information handling application component technology adapter layer disposed between the information handling application components framework and the universal renderers.

15. The system of claim 13, further comprising an information handling application rendering technology adapter layer disposed between the universal renderers and the information handling application rendering library.

16. The system of claim 13, wherein the information handling application comprises at least one of a web browser, a desktop application, a handheld computer application, and a cell phone.
